(19) United States
(12) Patent Application Publication
(10) Pub. No.: US 2007/0236486 A1
(43) Pub. Date: Oct. 11, 2007

(54) Method for transmitting a video signal and operation clock signal for a display panel

(75) Inventor: Ksuan-Chun Ku, Changhua City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Toppoly Optoelectronics Corp.

(21) Appl. No.: 11/402,114

(22) Filed: Apr. 11, 2006

(51) Int. Cl. G09G 5/00

(52) U.S. Cl. 345/213

(57) ABSTRACT

Architecture for transmitting a video signal and an control clock signal between an ASIC and a panel in a display is introduced. Two dummy shift registers (DSRs) and switches are used for sending out the control clock signal to an ASIC. The ASIC compares the control clock signal sent out from the DSR with the video signals desired to be sent to a display panel. Time difference between the control clock signal and the video signals is obtained by the ASIC and the video signals sent out from the ASIC are delayed with the time difference, in order to be synchronized with a shift pulse generated by operation of a shift register in the display.

### BACKGROUND OF THE INVENTION

1. Field of Invention

The present invention relates to architecture for transmitting a video signal and an operation clock signal for a panel in a display. More particularly, the present invention relates to a display panel video signal transmission and clock signal operation architecture which can compensate the delay caused by a driver in the display.

2. Description of Related Art

In designs of modem displays, different types of H-driver (or source drivers) are applied for driving pixels in the displays. However, the low temperature poly silicon (LTPS) process window is narrow, which causes the display signals desired to be transmitted to the display through multiple stages components of the drivers been delayed. The delay of the display signals through multiple stages components is not possible to be precisely and exactly predicted. The problem becomes much significant if components of the drivers are made from the multiple stage components on the panel.

One conventional method for compensating the delay is to adjust the sampling and holding time in an application-specific integrated circuit (ASIC), in order to synchronize video signals and control signals applied to the display, in which the video signals are directly applied to a display panel and the control signals are applied to the panel through the driver, including multiple stages components.

However, the sampling and holding time in the ASIC is adjusted manually, which is time-consuming and is not cost effective. In addition, some factors are not considered to synchronize the data applied to the display, for example, environmental factors such as an operating temperature is not considered, which makes the adjustment being not exact and in time.

Please refer to the FIG. 1, which shows a conventional architecture for transmitting video signals 140 between the ASIC 110 and the display panel 130. When video signals 140 are transmitted from the ASIC 110 to the display panel 130, corresponding control signals 112 (denoted as “H signal from ASIC” in FIG. 1) are also transmitted to the display panel 130 through a H-driver 120. Under the control of the H-driver 120, the video signals 140 are successively transmitted from the ASIC 110 to the display panel 130. Please refer to FIG.2, when both of the H signal 112 from ASIC 110 and the video signal are triggered to a logic high at time t1, the H signal 114 (denoted as “H signal after H-driver” in FIG.1) after the H-driver 120 is then triggered to the logic high at time t2, the time difference between the time t2 and time t1 is the delay time caused by the multiple-stage components in the H-driver 120.

Please refer to FIG. 3, which shows a characteristic signal delay time with LTPS components at different applied operation voltage. For example, line 310 is the characteristic signal delay time of circuits with LTPS p-type transistor with a threshold voltage Vth=0.5V, U=150, U representing mobility, and LTPS n-type transistor with a threshold voltage Vth=−0.5V, U=140. The delay time shown in line 310 is 65 nanoseconds (ns). Line 320 is the characteristic signal delay time of circuits with LTPS p-type transistor with a threshold voltage Vth=1.5V, U=80 and LTPS n-type transistor with a threshold voltage Vth=−1.5V, U=70. The delay time shown in line 320 is 98 ns. Line 330 is the characteristic signal delay time of circuits with LTPS p-type transistor with a threshold voltage Vth=2.5V, U=50 and LTPS n-type transistor with a threshold voltage Vth=−2.5V, U=40. The delay time shown in line 320 is 148 ns. Because of manufacturing variations of the components of the drivers, the delay time is different, which makes the delay time of signals transmitted to the display being unpredictable.

Please refer to FIG. 4A, which shows conventional circuit diagrams of a horizontal driving circuit (H-driver) for a display. In the H-driver 400, a start pulse STHR or STHL for start shift operation of the shift register set 430 is transmitted, which depends on the direction of shift operation performed on the shift register set 430. A shift register set 430 include a plurality of shift registers (SR₁, SR₂, SR₃ ˜SRₙ) connected in series receives the start pulse, for example, STHR and then performs shifting operation in synchronism with a horizontal clock signal CKH to successively output shift pulses respectively from the shift registers (from SR₁, SR₂, . . . to SRₙ) to corresponding sampling switches HSWs (430₁, 430₂, 430₃, . . . 430ₙ), for example, the output shift pulse 432 from shift register SR₁. Under the control of the output shift pulses , the video signals are transmitted to a pixel array section 440, which includes gate lines extending along rows, signal lines extending along columns, and pixels disposed at intersecting points of the gate lines and the signal lines.

Please refer to FIG. 4B, which shows a operational time chart of the H-driver 400 as shown in FIG. 4A. The H-driver 400 connected to the signal lines in the pixel array section 440 and operates in response to the horizontal clock signal CKH to successively write the video signals to the pixels of the selected row. More particularly, the H-driver 400 successively samples the video data (RGB) and holds the sampled signals to the signal lines. The sampled and hold signals (as denoted in FIG. 4B as “SH”) SH1-SH6, for example, are successively supplied to the pixels of the array section 440 at time t1 to time t6.

The shift register performs shifting operation in synchronism with the horizontal clock signal CKH to successively output shift pulses respectively from the shift stages to corresponding sampling switches HSW. However, a delay time will occur when the shift register successively outputs shift pulses in synchronism with the horizontal clock signal CKH after the multiple-staged components of the H-driver, the video data (RGB) will not be successively sampled and hold and transmitted to the pixels of the array section 440 as required. It will cause some serious problems. In the conventional method to avoid the problem, the sampling and holding time can be adjusted by the users; however, it is time-consuming and is not cost effective. In addition, the delay time can not be exactly measured and predicted, which makes the outcome of the manual adjustment not acceptable as desired.

A method for improving the problem of delay caused by the multiple-staged components is proposed, in which an operation voltage is increased for these multiple-staged components. Please refer to FIG. 5, when the operation voltage V_{DD} is equal to 8.5 volts (V), the delay time is about 148 ns, however, if the operation voltage V_{DD} is increased from 8.5 V to 12V, the delay time is reduced to 116 ns. However, simply increasing the operation voltage can not match all kinds of delay occurred in the multiple-staged components. SUMMARY OF THE INVENTION

The present invention provides architecture for transmitting a video signal and an control clock signal between an application-specific integrated circuit (ASIC) and a display panel, which can avoid the delay between video signals and output shift pulses in the driver of the display. One embodiment of the present invention provides architecture and method for transmitting a video signal and an control clock signal between an application-specific integrated circuit (ASIC) and a display panel. In the method for providing signals to a display panel, a driving operation is initialized by a start pulse. A control clock signal for the driving operation is transmitted and a feedback signal is generated from a signal through a dummy shift register. The delay time between the feedback signal and a video signal is compared and calculated within ASIC. Transmission of the video signal is delayed to the display panel according to the delay time to synchronize the final video signal with a shift pulse generated by operation of a shift register in the display panel.

Dummy shift register (DSR) and switches are used for sending out the shift pulse to ASIC. The ASIC compares the video signal with the signal from the DSR. Time difference between the video signal and the signal from the DSR is obtained by the ASIC and the final video signals sent out from the ASIC are delayed with the time difference, in order to be synchronized with a shift pulse generated by operation of a shift register in a horizontal driving circuit of a display apparatus. The operation of adjusting the phase of the video signals transmitted to the display panel can be performed every one or more frame cycles or when the display panel is turned on, which depends on the design required.

One embodiment of the present invention provides a display apparatus, which comprises a panel including a horizontal driving circuit, a vertical driving circuit and a pixel array section. The pixel array section comprises a plurality of gate line extending along rows, a plurality of signal lines extending along columns and a plurality of pixels disposed at intersecting points of the gate lines and the signal lines. The horizontal driving circuit is connected to the signal lines and operates in response to a control clock signal to successively write a video signal into the pixel array section. When the horizontal driving circuit operates in response to the control clock signal, a feedback signal is generated and sent back to an external circuit for providing the clock signal and the video signal. Transmission of the video signal is delayed to the display panel according to a result of the comparison and calculation within ASIC to synchronize the video signal with a shift pulse generated by operation of a shift register in the horizontal driving circuit.

In the embodiment of the display apparatus, the horizontal driving circuit comprises a shift register with a plurality of shift stages and a sample switch set with a plurality of sample switches, each of the sample switch connecting to one of the shift stages in the shift register, each of the sample switches is controlled by the corresponding shift stage to successively write the video signal into the pixel array section. The horizontal driving circuit operates in response to the clock signal comprises the shift register performs a shifting operation when receives a start pulse to successively through the plurality of stages based on the clock signal and generates a plurality of shift pulses according to the shifting operation, and each of the sample switches samples and holds the video signal and successively transmits the sampled and hold video signal to the pixel array section under control of the corresponding one of the shift pulses.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a conventional architecture for transmitting video signals between the ASIC and the panel in a display.

FIG. 2 is a timing chart illustrating operation of the conventional architecture of FIG. 1.

FIG. 3 shows a relationship between a delay time of different components and an operation voltage applied thereto.

FIG. 4A shows conventional circuit diagrams of a horizontal driving circuit (H-driver) of a driver for a display.

FIG. 4B shows a timing chart illustrating operation of the H-driver of the driver as shown in FIG. 4A.

FIG. 5 shows a relationship between a delay time of different components and an operation voltage applied thereto in another proposed method for improving the problem of delay caused by the multiple-staged components.

FIG. 6 shows an embodiment of circuit block diagrams illustrating architecture for transmitting video signals between the ASIC and the panel in a display, according to the present invention.

FIG. 7 shows circuit block diagrams of a display apparatus of an embodiment according to present invention.

FIG. 8 shows a schematic circuit of an embodiment of the switch element of FIG. 7.

FIG. 9 shows a timing chart illustrating operation of a display apparatus of an embodiment of the invention.

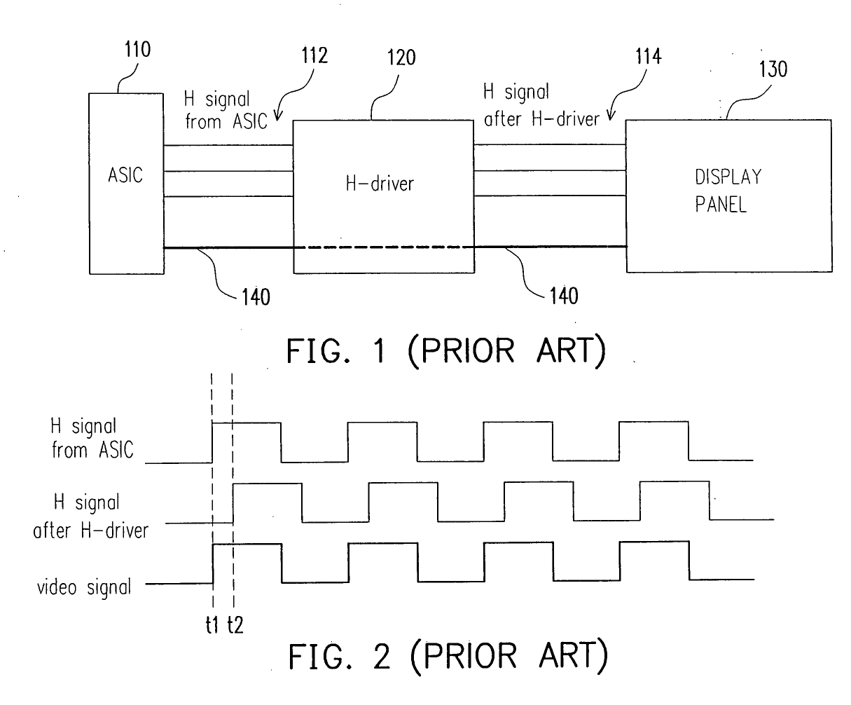

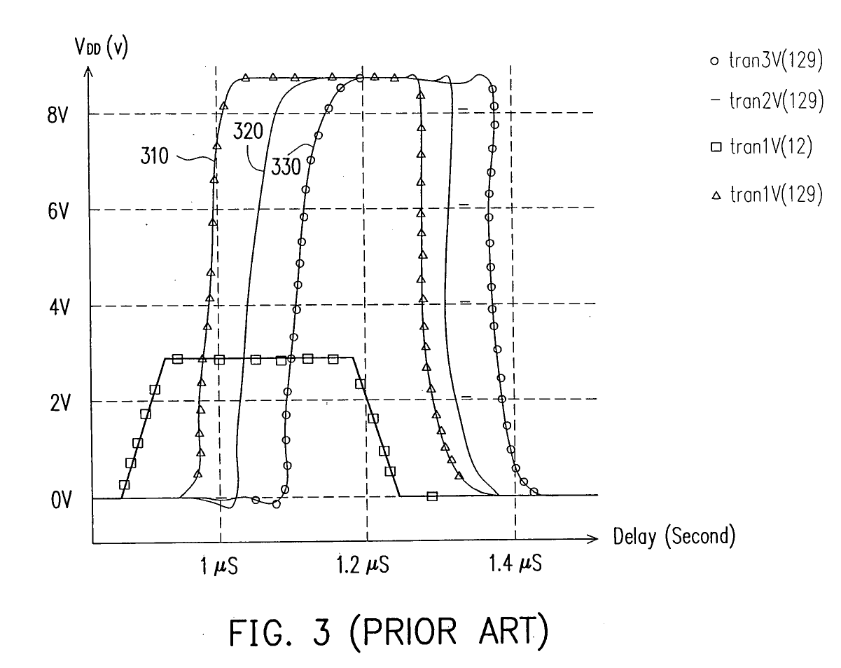

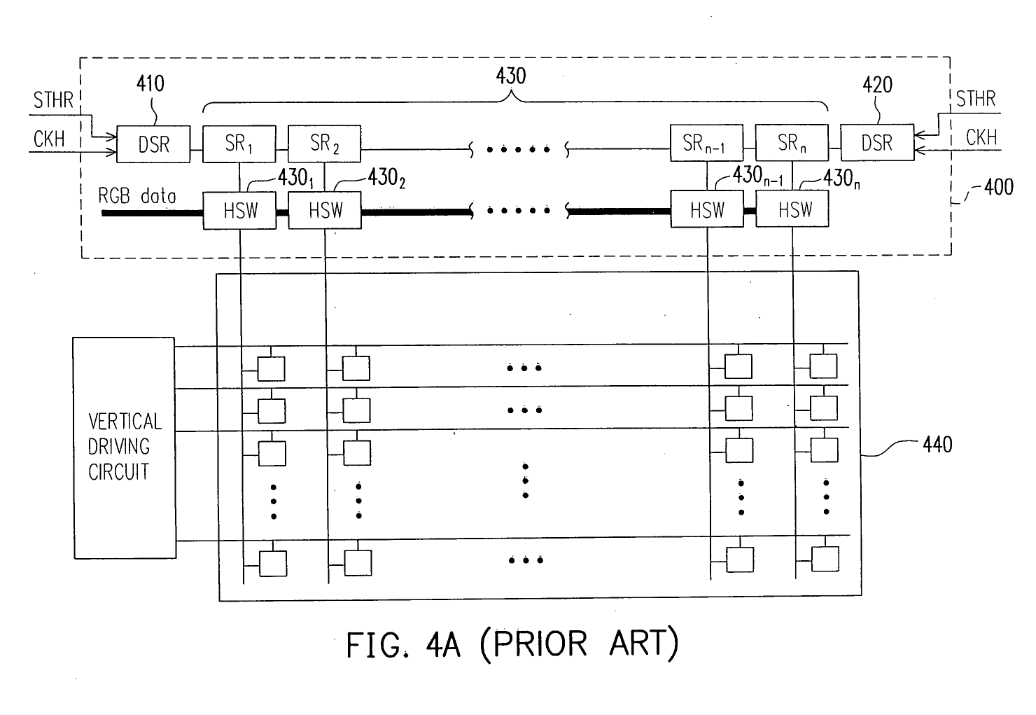

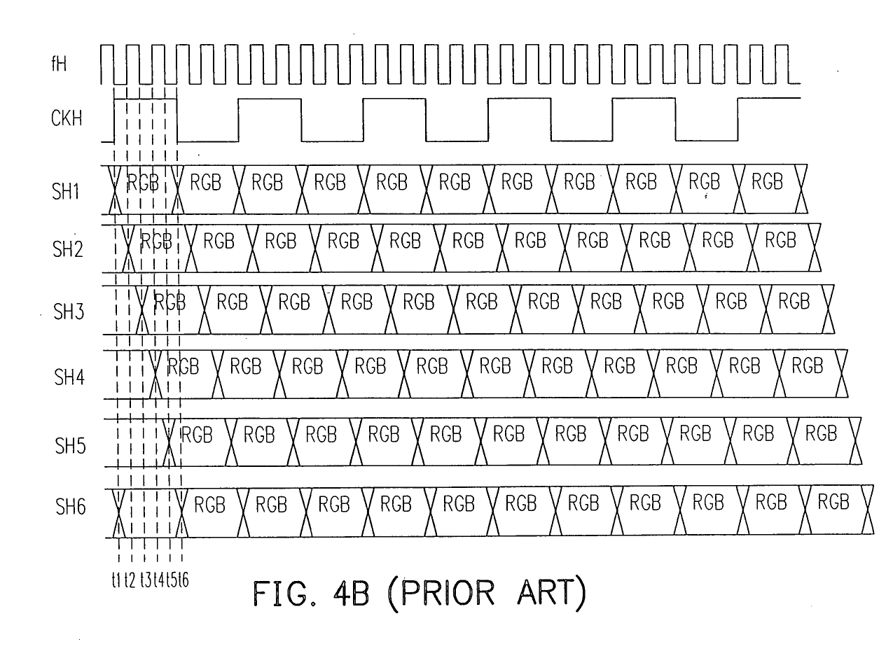

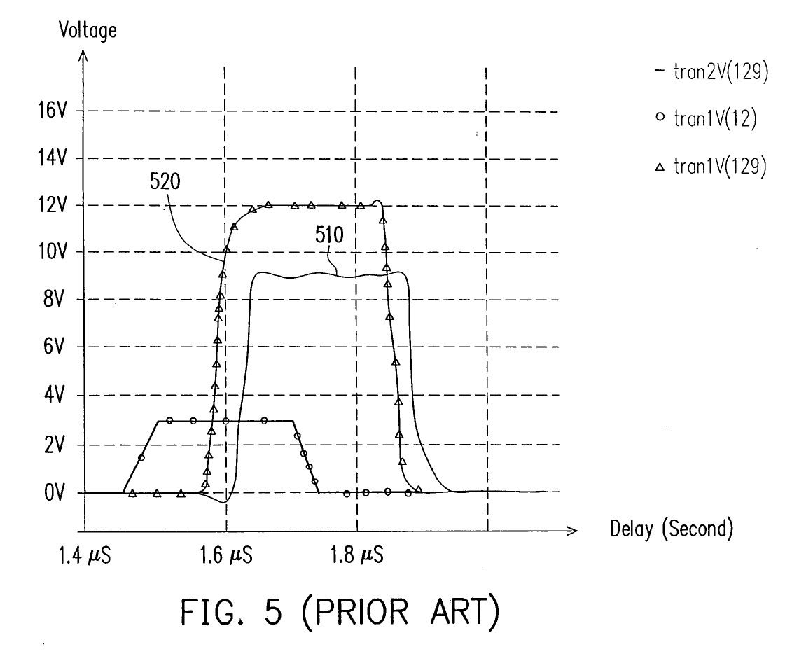

### DESCRIPTION OF EMBODIMENTS

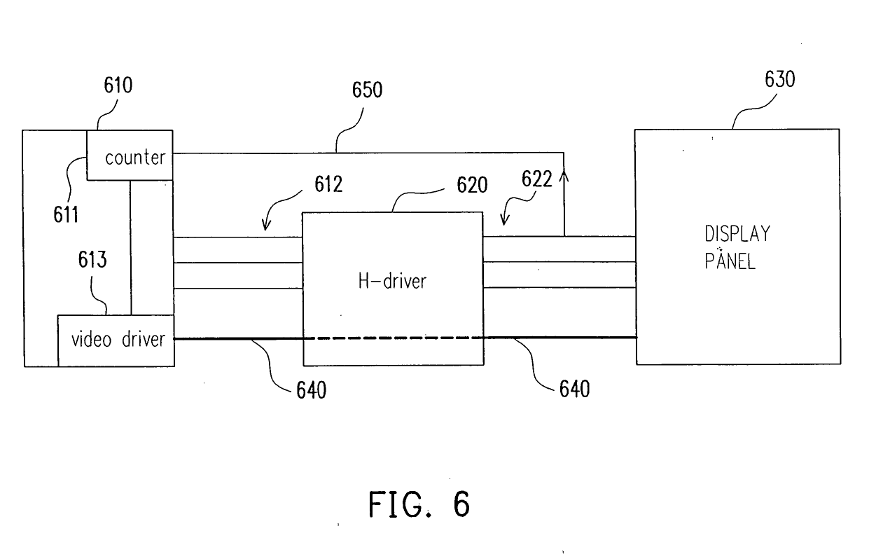

Please refer to the FIG. 6, which shows an embodiment of circuit block diagrams illustrating architecture for transmitting video signals between an application-specific integrated circuit (ASIC) 610 and a display panel 630, according to the present invention. When video signals 640 are transmitted from the ASIC 610 to a display panel 630 of the panel 600, corresponding control clock signals 612 are also transmitted to the display panel 630 through an H-driver 620. Under the control of the H-driver 620, the video signals 640 are successively transmitted from the ASIC 610 to the display panel 630. In order to avoid dismatch in time difference between the transmitted video signals and the control clock signals 622 after the H-driver 620, a feedback signal 650 is sent back to the ASIC 610. By using the feedback signal 650, the video signals 640 are transmitted to the display panel 630 in considering the delay revealed from the feedback signal 650, to be in synchronism with the control clock signals 622, which are transmitted to the display panel 630. In one embodiment, by using the feedback signal 650, the ASIC 610 can count the delay every one frame cycle or more than one frame cycles.

The ASIC 610 includes a counter 611 and a video driver 613. After a frame cycle or a plurality of frame cycles, the counter 611 will extract an ASIC count time from the feedback signal 650, for example, counting phase difference between the feedback signal 650 and the video signals 640. Then the ASIC count time will be transmitted to the video driver 613 and the video driver 613 will adjust the phase to transmit the video signals to the array section of the display panel 630, in order to be in synchronism with the control clock signals 622 after the H-driver 620.

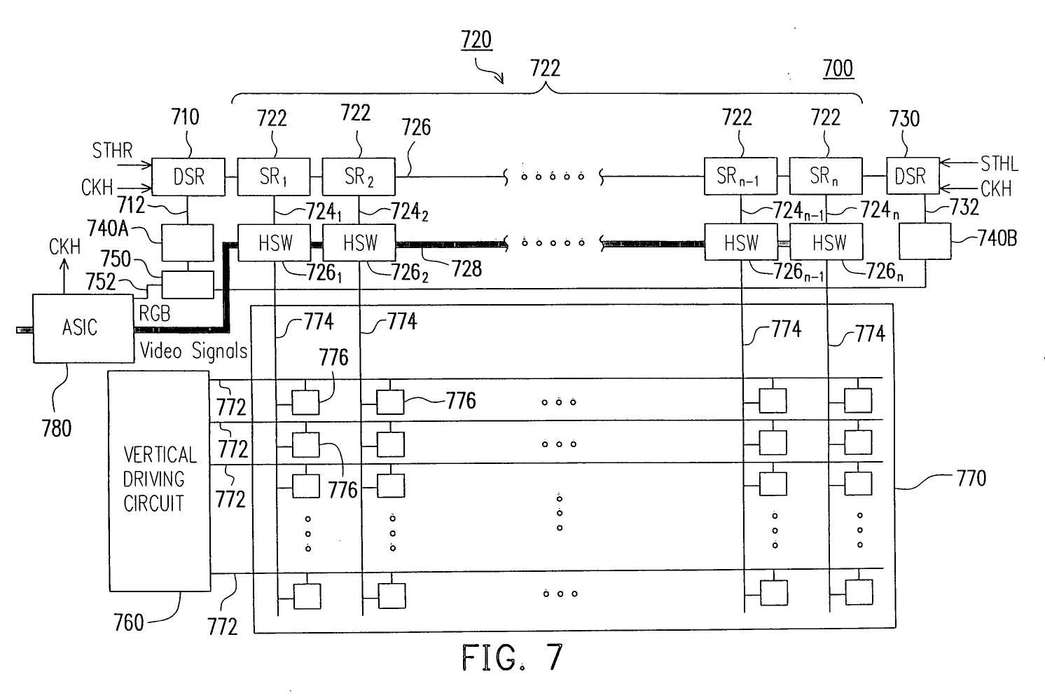

Please refer to FIG. 7, which shows circuit block diagrams of a display apparatus of an embodiment according to present invention. The display apparatus 700 includes a panel including a horizontal driving circuit 720, a vertical driving circuit 760 and a pixel array section 770 and other necessary circuits not shown are formed in an integrated manner, for example. The pixel array section 770 includes gate lines 772 extending along rows, signal lines 774 extending along columns and pixels 776 disposed at intersecting points of the gate lines 772 and the signal lines 774. The vertical driving circuit 760 is disposed beside the pixel array section 770 and connected to the gate lines 772 to successively select the rows of the pixels 776. In an alternative embodiment, the panel can includes two vertical driving circuit disposed beside two sides of the pixel array section 770.

The horizontal driving circuit 720 is connected to the signal lines 774 and operates in response to a control clock signal of a predetermined period to successively write video signals into the pixels 776 of the selected row. The display apparatus 700 is applied with an external control clock signal CKH which is used as a reference to perform operation of the horizontal driving circuit 720. In addition, the horizontal driving circuit 720 is further applied with a horizontal start pulse STH and operates in response to the control clock signal CKH to successively write the video signals into the pixels 776 of the selected row. More particularly, the horizontal driving circuit 720 successively samples the video signals supplied thereto from the outside and holds the sampled signals to the signal lines 774.

In the horizontal driving circuit 720, the start pulse STH for shift operation is transmitted from a dummy shift register (DSR) 710 or DSR 730, which depends on the direction of the shift operation to a shift register set 722. The DSR 710 or DSR 730 is triggered by a horizontal start pulse STHR/STHL, which respectively represents the direction of the shift operation from a right side or from a left side indicated in the start pulse STH. The shift register set 722 include a plurality of shift stages (SR₁, SR₂, SR₃ ˜SRₙ) in series, receives the start pulse STHR and then performs shifting operation in synchronism with the horizontal clock signal CKH to successively output shift pulses 724₁, 724₂, . . . , 724ₙ₋₁, 724ₙ, respectively from the shift stages (SR₁˜SRₙ) to corresponding one of sampling switches HSWs (726₁, 726₂, . . . , 726ₙ₋₁, 726ₙ). Under the control of the output shift pulses 724₁, 724₂, . . . , 724ₙ₋₁, 724ₙ, the video signals are transmitted to a pixel array section 770 through the signal lines 774.

In the embodiment, two redundant switches 740A and 740B are respectively disposed below and connected to the DSR 710 and DSR 730. A switch element 750 is connected to the redundant switches 740A and 740B. When the direction of the shift operation is from shift stages SR₁ to SRₙ, a DSR signal 712 from the DSR 710 is transmitted to the redundant switch 740A and then to the switch element 750. A real DSR (“RDSR” hereafter) signal 752 is generated accordingly by the switch element 750 and is transmitted to an application-specific integrated circuit (ASIC) 780. In other case for an opposite polarity, if the direction of the shift operation is from shift stages SRₙ to SR₁, a DSR signal 732 from the DSR 730 is transmitted to the redundant switch 740B and then to the switch element 750. The RDSR signal 752 is generated accordingly by the switch element 750 and is transmitted to the ASIC 780. By comparing the RDSR signal 752 and the horizontal clock signal CKH in the ASIC 780, or in an alternative embodiment, by comparing the RDSR signal 752 and the video signal in the ASIC 780, a delay time is generated for phase adjustment, as proposed in the invention. An phase adjustment is generated according to the delay time and a ASIC deal time for the ASIC 780 to compare the time difference. A FDATA signal, which indicates that the end of the data to be transmitted to the panel, is transmitted based on the phase adjustment. The operation of adjusting the phase of the video signal transmitted to the pixel array section 770 can be performed every frame cycle or two or more frame cycles, which depends on the design required.

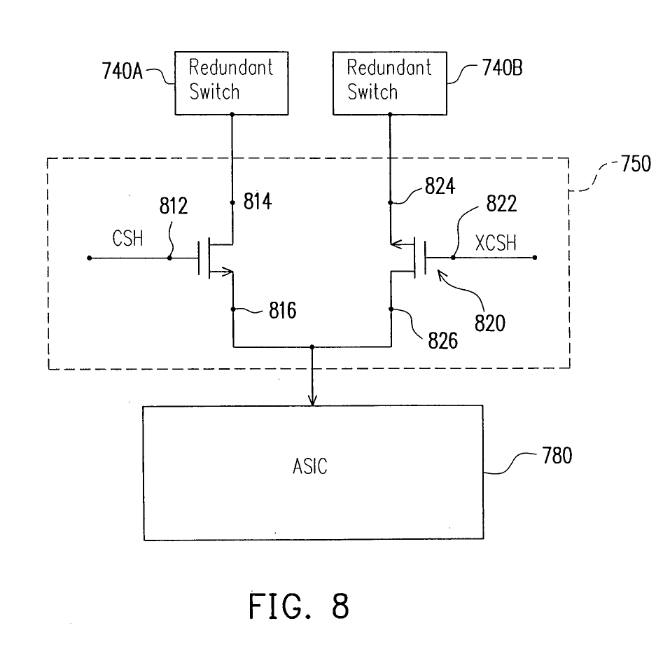

Please refer to FIG. 8, which shows a schematic circuit of an embodiment of the switch element 750 of FIG. 7. A switch element 750 of the embodiment includes two NMOS transistors 810 and 820. A gate terminal 812 of the NMOS transistor 810 is connected to a scan direction control signal CHS for indicating the polarity of a normal scanning direction in the horizontal driving circuit, a drain terminal 814 of the NMOS transistor 810 is connected to a redundant switch 740A, and a source terminal 816 of the NMOS transistor 810 is connected to an ASIC 780. A gate terminal 822 of the NMOS transistor 920 is connected to a scan direction control signal XCHS, which is a complementary scan direction control signal to the scan direction control signal CHS for indicating the polarity of a reverse scanning direction in the horizontal driving circuit. A drain terminal 824 of the NMOS transistor 820 is connected to a redundant switch 740B, and a source terminal 826 of the NMOS transistor 820 is also connected to the ASIC 780.

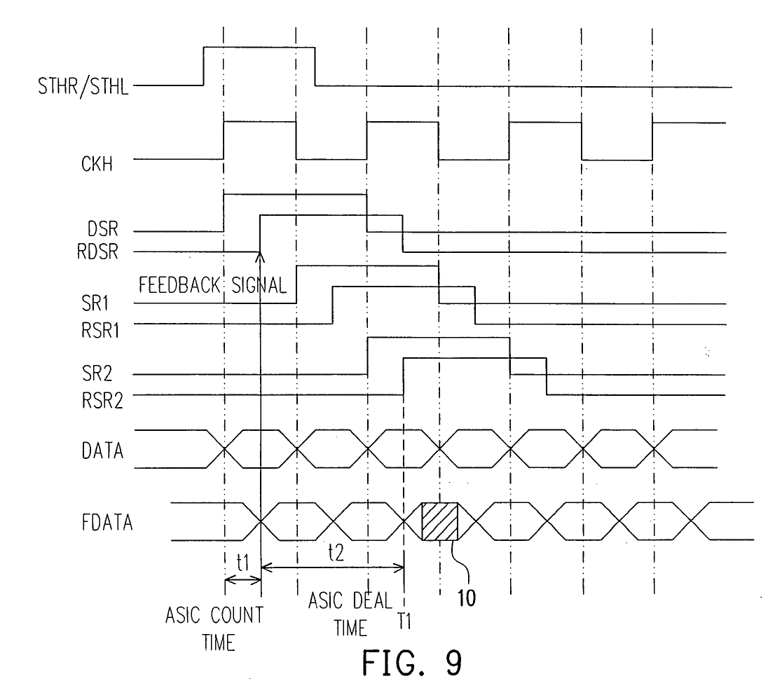

Please refer to FIG. 9, which shows a timing chart illustrating operation of a display apparatus of an embodiment of the invention. When a horizontal start pulse STH (STHR or STHL, which depends on the normal or reverse scanning direction) is triggered to initialize a horizontal driving circuit of the display apparatus, an control clock signal CKH is applied first to a dummy shift register (DSR). A DSR signal is supposed to be generated by the dummy shift register DSR. However, because of delay caused by manufacturing differences for components in the display apparatus, or environmental factors including operating temperature or humidity etc., a real DSR (RDSR) signal is output by the dummy shift register DSR. A time difference exists between the DSR signal supposed to be generated and the real DSR signal. The real DSR signal (RDSR) is the feedback signal for delay time comparison and calculation within ASIC.

The real DSR (RDSR) is generated from the dummy shift register DSR after time period t1 after the DSR being triggered or initialized. Two shift stages are shown in FIG. 9 for explanation for example; however, as illustrated in FIG. 7, the shift register includes a plurality of shift stages. In FIG. 9, a first shift pulse SRI is supposed to be output from the first shift stage in the first cycle of the control clock signal CKH. However, due to delay caused by some factors, for example, manufacturing differences, a first real shift pulse RSR1 is generated. In the second cycle of the control clock signal CKH, a second real shift pulse RSR2 is output from the second shift stage, instead of the second shift pulse SR2. Real shift pulses are output from the shift stages in the shift register and have also time delay because of the same factors mentioned above.

The video signals are also successively sampled and hold and then applied to pixels of an array section of the display apparatus. After a frame cycle or a plurality of frame cycles, a time period t1 is extracted from the feedback signal and the ASIC will count the time period t1 and save as an ASIC count time. Then the ASIC will adjust the phase for beginning to transmit the video signals to the array section of the display, in order to be in synchronism with the real DSR signal. The time required for the ASIC to adjust the phase for beginning to transmit a FDATA signal, which is the first data being transmitted to the pixel array section is the time T1 in considering the ASIC count time and a ASIC deal time for handling the synchronization, as shown in the FIG. 10. The video signal FDATA is adjusted to be in synchronism with the shift operation and begins to transfer at time T1, which is totally in sum of the ASIC count time t1 plus the ASIC deal time t2 delayed behind the time without considering the compensation time of delay caused by the driver. The first data FDATA being transmitted to the pixel array section is synchronized with the real shift pulse (RSR2).

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for providing signals to a display panel, comprising:
initializing a driving operation by a start pulse;
transmitting a control clock signal for the driving operation, and a feedback signal is generated through a dummy shift register; and
comparing the feedback signal and a video signal and delaying transmission of the video signal to the display panel according to a result of the comparison to synchronize the video signal with an shift pulse generated by shift operation of a shift register in the display panel.

2. The method of claim 1, wherein comparing the feedback signal and the video signal to obtain time difference between the feedback signal and the video signal.

3. The method of claim 1, wherein the comparing the feedback signal and the video signal to synchronize the video signal with the shift pulse is done every frame cycle.

4. The method of claim 1, wherein the comparing the feedback signal and the video signal to synchronize the video signal with the shift pulse is done every a plurality of frame cycles.

5. The method of claim 1, wherein the comparing the feedback signal and the video signal to synchronize the video signal with the shift pulse is done whenever the display panel is turned on.

6. The method of claim 1, wherein a delay time for transmission of the video signal is generated according to a time difference between the feedback signal and the video signal plus a deal time for dealing with the comparison.

7. A display apparatus, comprising a panel including
a horizontal driving circuit:
a vertical driving circuit; and
a pixel array section, wherein the horizontal driving circuit is connected to the pixel array section and operates in response to a control clock signal to successively write a video signal into the pixel array section,
wherein when the horizontal driving circuit operates in response to a control clock signal to successively write a video signal into a pixel array section in the display apparatus, a feedback signal is generated from a signal is transmitted through a dummy shift register and sent back to an external circuit which provides the clock signal and the video signal, transmission of the video signal is delayed to the pixel array section according to a result of the comparing the feedback signal and the video signal, to synchronize the video signal with an shift pulse after shift operation of a shift register in the horizontal driving circuit.

8. The display apparatus of claim 7, further comprising a dummy shift register, wherein the feedback signal is generated by a signal after the control clock signal being transmitted through a dummy shift register before the shift register.

9. The display apparatus of claim 8, further comprising a switch for sending the feedback signal from the dummy shift register to the external circuit under control of a scan direction in the horizontal driving circuit.

10. The display apparatus of claim 7, wherein the comparing the feedback signal and the video signal to synchronize the video signal with the shift pulse is done every frame cycle.

11. The display apparatus of claim 7, wherein the comparing the feedback signal and the video signal to synchronize the video signal with the shift pulse is done every a plurality of frame cycles.

12. The display apparatus of claim 7, wherein the comparing the feedback signal and the video signal to synchronize the video signal with the shift pulse is done whenever the display apparatus is turned on.

13. The display apparatus of claim 7, wherein the horizontal driving circuit comprising a shift register with a plurality of shift stages and a sample switch set with a plurality of sample switches, each of the sample switch connecting to one of the shift stages in the shift register, each of the sample switches is controlled by the corresponding shift stage to successively write the video signal into the pixel array section.

14. The display apparatus of claim 13, wherein the horizontal driving circuit operates in response to the clock signal comprises the shift register performs a shifting operation when receives a start pulse to successively through the plurality of stages based on the clock signal and generates a plurality of shift pulses according to the shifting operation, and each of the sample switches samples and holds the video signal and successively transmits the sampled and hold video signal to the pixel array section under control of the corresponding one of the shift pulses.

15. The display apparatus of claim 7, wherein a delay time for transmission of the video signal is generated according to a time difference between the feedback signal and the video signal plus a deal time for the external circuit to deal with the comparison.
